(19) United States
(12) Patent Application Publication
(10) Pub. No.: US 2004/0190914 A1
(43) Pub. Date: Sep. 30, 2004

(54) Burst mode optical receiver

(76) Inventors: Ho Yong Kang, Daejeon-city (KR); Hyun Kyun Choi, Daejeon-city (KR); Quan Le, Daejeon-city (KR); Tae Whan Yoo, Daejeon-city (KR); Hyeong Ho Lee, Daejeon-city (KR); Sang Gug Lee, Daejeon-city (KR); Man Seop Lee, Daejeon-city (KR); Yong Hun Oh, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/810,203

(22) Filed: Mar. 26, 2004

(30) Foreign Application Priority Data
Mar. 29, 2003 (KR) 2003-19822

(51) Int. Cl. H04B 10/06

(52) U.S. Cl. 398/202

(57) ABSTRACT

A burst mode optical receiver includes: a photodiode which converts an input optical signal into a current signal; a pre-amplifier which converts the current signal into a voltage signal; a single-to-differential converter which converts the single voltage signal output from the pre-amplifier into differential signals; a post amplifier which amplifies the differential signals and cancels an offset occurring during the amplification or offsets inherited from the differential signals; and a discriminator which discriminates data from the differential signals.

### BACKGROUND OF THE INVENTION

This application claims the priority of Korean Patent Application No. 2003-19822, filed on Mar. 29, 2003, in the Korean Intellectual Property Office, the disclosure of which is incorporated herein in its entirety by reference.

1. Field of the Invention

The present invention relates to a burst mode optical receiver, and more particularly, to a burst mode optical receiver of feed-forward type.

2. Description of the Related Art

There has been recently studied on a Time Division Multiple Access (TDMA) method of transmitting a high-speed multimedia signal using a fast packet signal. A TDMA system receives signals from a plurality of subscribers using one optical receiver in order to reduce costs incurring for the subscribers. Thus, the magnitude and phase of a received packet signal vary with each packet. This packet signal is referred to as a burst signal, and a burst mode optical receiver receives the burst mode signal.

In a conventional point-to-point communication system, a linear channel output is alternating current (AC)-coupled to a data decision circuit to fix a decision threshold voltage, which is necessary for signal discrimination. In order to receive the burst mode signal using the optical receiver, an idle time, which is represented as the sum of a guard time and a preamble time, between packets needs to be increased. However, the increase in the idle time results in a reduction in transmission efficiency of packets. When capacity of a coupling condenser is reduced to reduce the idle time, a different apparatus is required to encode and/or decode transmitted data. Thus, a burst mode optical receiver is required to manage input signals having short idle times, and broad dynamic ranges, and different magnitudes.

A direction current (DC) coupling method is generally used to remove the above-described influence of the coupling condenser from the burst mode optical receiver. In addition, the power variation of the input signal is detected and is either fed-back to a pre-amplifier or fed-forward to an amplifier of the next circuit, thereby obtaining the optimum threshold value for a decision circuit, in most of the cases, a limiting amplifier, or a data discriminator which discriminates final data for the input signals. The burst mode optical receiver is classified into a feed back type if the said power variation is detected and fed back to the preamplifier, and a feed-forward type if the said power variation is detected and fed forward to the next amplifier.

FIG. 1 is a block diagram of a conventional feedback type burst mode optical receiver. Referring to FIG. 1, the conventional burst mode optical receiver is disclosed in U.S. Pat. No. 6,005,279 and includes a photodiode 10, a main pre-amplifier 11, a tracking pre-amplifier 12, an operational (OP)-amplifier 13, an automatic threshold controller (ATC) 14, a post amplifier 15, and a discriminator 16.

The conventional burst mode optical receiver includes the ATC 14 between the tracking pre-amplifier 12 and the OP-amplifier 13 to perform DC coupling. The photodiode 10 receives an optical signal, converts the optical signal into a current, and outputs the current. The main pre-amplifier 11 converts the current into a voltage and outputs the voltage. An output of the main pre-amplifier 11 is input to an input port of the OP-amplifier 13 and an output of the tracking pre-amplifier 12 is input to the other input port of the OP-amplifier 13. The tracking pre-amplifier 12 is identical to the main pre-amplifier 11. The tracking pre-amplifier 12 output a DC voltage that match with the DC voltage output of the main pre-amplifier 11. The matched voltage is set to a DC reference voltage of the OP-amplifier 13. The tracking pre-amplifier 12 tracks elements affecting the main pre-amplifier 11, for example, variations in supplied voltage or temperature, allowing its output to match with the DC voltage of the main pre-amplifier 11.

The ATC 14 is placed between an output terminal and an input terminal of the opposite sign of the OP-amplifier 13, where the input node is connected to the tracking pre-amplifier 12, so that a threshold for determining a logic value of a received signal becomes the middle value of voltage swing at output from the main pre-amplifier 11. Differential signals output from the OP-amplifier 13 therefore swing symmetrically. The post amplifier 15 amplifies the differential signals, and the discriminator 16 discriminates data of a logic “0” or “1” from signals output from the post amplifier 15 and outputs the discriminated data.

FIG. 2 is a block diagram of a conventional burst mode optical receiver of feed-forward type. Referring to FIG. 2, the conventional burst mode optical receiver is disclosed in U.S. Pat. No. 5,475,342 and includes a photodiode 21, a pre-amplifier 22, a post amplifier 23, and a discriminator 24. The post amplifier 23 includes a plurality of limiting amplifiers 231 and a plurality of ATCs 232. An output of a front stage is input to a first input terminal of the limiting amplifier 231. The ATC 232 receives the output of the front terminal and outputs a reference voltage to a second input terminal of the limiting amplifier 231.

The pre-amplifier 22 converts a current output from the photodiode 23 into a voltage. The limiting amplifier 231 amplifies signals input through the first input terminals. When the input signal is greater than a reference voltage, the limiting amplifier 231 limits a level of the amplified output. The ATC 232 allows the reference voltage to have a middle value of the maximum and minimum values of the input signal. The discriminator 24 discriminates data of a logic “0” or “1” from a signal finally output from the post amplifier 23 and outputs the discriminated data.

However, the feedback type burst mode optical receiver described in FIG. 1 uses a high-speed device for feedback. A feedback circuit requires a considerable amount of filtering in order to avoid a positive feedback in a high frequency. Thus, a large capacitor should be used, so that it takes a long time for the feedback circuit to reach a stable value.

Since the burst mode optical receiver of feed-forward type described in FIG. 2 has a single-ended output, it is difficult to design a clock and data recovery circuit at a high data rate. Also, a single-ended signal is easy to be exposed to noise compared to other types of signals. Accordingly, it is difficult to avoid a leakage of a signal from an output side to an input side when the entire burst mode optical receiver of feed-forward type gets integrated into a single chip. As a result, the operation of the feed-forward type burst mode optical receiver is unstable.

### SUMMARY OF THE INVENTION

The present invention provides a feed-forward type burst mode optical receiver that converts a single-ended output into differential outputs and automatically cancels an intrinsic offset inside the receiver.

According to an aspect of the present invention, there is provided a burst mode optical receiver comprising: a photodiode which converts an input optical signal into a current signal; a pre-amplifier which converts the current signal into a voltage signal; a single-to-differential converter which converts the single voltage signal output from the pre-amplifier into differential signals; a post amplifier which amplifies the differential signals and cancels an offset occurring during the amplification or an offset inherited from the differential signals; and a discriminator which discriminates data from the differential signals.

### BRIEF DESCRIPTION OF THE DRAWINGS

The above and other characteristics and advantages of the present invention will become more apparent by describing in detail exemplary embodiments thereof with reference to the attached drawings in which:

FIG. 1 is block diagram of a conventional burst mode optical receiver of feedback type;

FIG. 2 is a block diagram of a conventional burst mode optical receiver of feed-forward type;

FIG. 3 illustrates the structure of a general passive optical network (PON) system;

FIG. 4 is a block diagram of a burst mode optical receiver according to the present invention;

FIG. 5 is a detailed block diagram of a single-to-differential converter of FIG. 4;

FIG. 6 illustrates a first embodiment of a post amplifier of FIG. 4; and

FIG. 7 illustrates a second embodiment of the post amplifier of FIG. 4.

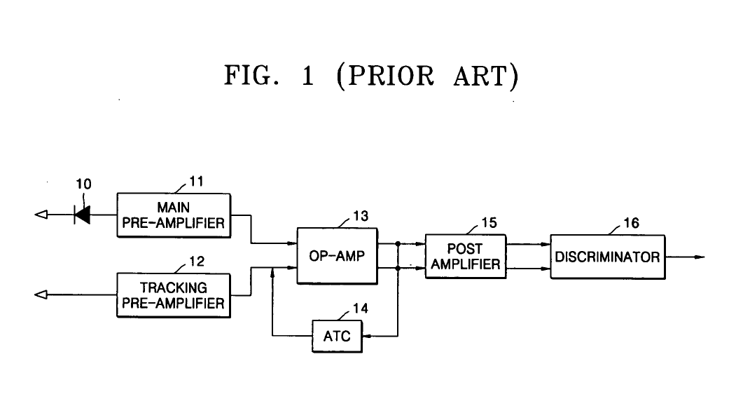

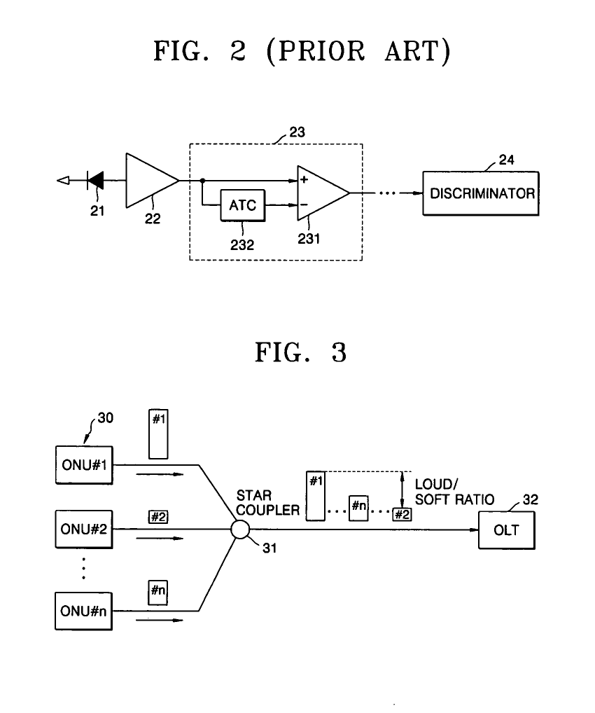

### DETAILED DESCRIPTION OF THE INVENTION

Hereinafter, the present invention will be described in detail with reference to the attached drawings.

FIG. 3 illustrates the structure of a typical PON system. Referring to FIG. 3, the general PON system includes a plurality of optical network units (ONUs) 30, a star coupler 32, and an optical line terminal (OLT) 32. Time slots are dynamically or fixedly allocated to the ONUs 30 to transmit signals through uplink paths proceeding from the ONUs 30 toward the OLT 32. Optical signals output from the ONUs 30 are combined by the star coupler 31 and proceed toward the OLT 32. The ONUs, which are closer to the OLT 32, transmit higher signals compared to the other ONUs. Since the signals transmitted from the ONUs have widely different amplitudes, a burst mode optical receiver located in the OLT 32 is reset to an initial state before each burst reaches, so as to process burst signals with different amplitudes. The loud/soft ratio refers to a difference between the maximum levels of the greatest burst and the smallest burst. In the present invention, components of the burst mode optical receiver are reset regardless of the loud/soft ratio.

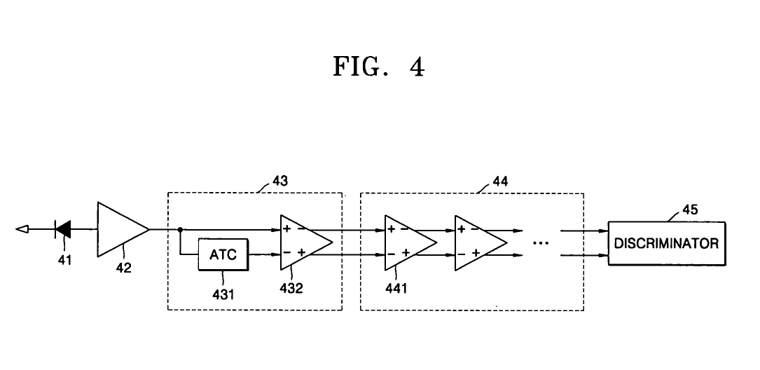

FIG. 4 is a block diagram of a burst mode optical receiver according to the present invention. Referring to FIG. 4, the burst mode optical receiver includes a photo-detector 41, a pre-amplifier 42, a single-to-differential converter 43, a post amplifier 44, and a discriminator 45. The single-to-differential converter 43 includes an ATC 431 and a differential amplifier 432, and the post amplifier 44 includes a plurality of differential amplifiers 441.

The photo-detector 41 converts an input optical signal into a current signal. The pre-amplifier 42 converts the current signal into a voltage signal. The single-to-differential converter 43 amplifies a single-ended signal output from the pre-amplifier 42, converts the amplified signal into differential outputs, and outputs two differential signals.

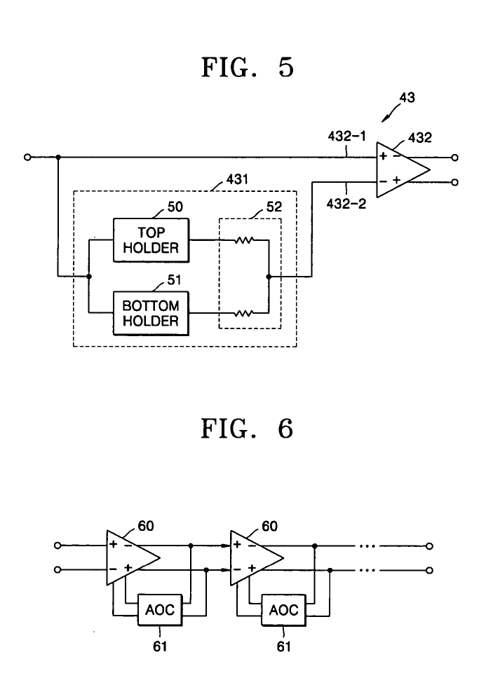

FIG. 5 is a detailed block diagram of the single-to-differential converter 43 of FIG. 4. Referring to FIG. 5, the single-to-differential converter 43 includes the ATC 431 and the differential amplifier 432. The ATC 431 includes a top holder 50, a bottom holder 51, and a voltage divider 52.

The differential amplifier 432 includes a signal voltage input terminal 432-1, a reference voltage input terminals 432-2, and two differential output terminals. The differential amplifier 432 outputs symmetrical differential voltages with a predetermined offset for a signal voltage waveform input to the signal voltage input terminal 432-1, based on a reference voltage input to the reference voltage input terminal 432-2.

The ATC 431 is connected between the pre-amplifier 42 and the reference voltage input terminal 432-2, detects the maximum and minimum levels of a voltage waveform output from the pre-amplifier 42, and outputs a substantial middle value of the maximum and minimum levels as a reference voltage to the reference voltage input terminal 432-2. The top holder 50 detects the maximum level of a signal input to the pre-amplifier 42 and holds the maximum level for a predetermined period of time. The bottom holder 51 detects the minimum level of the input signal and holds the minimum level for a predetermined period of time. The voltage divider 52 outputs a substantial middle value among values output from the top holder 50 and the bottom holder 51.

The post amplifier 44 includes a plurality of amplifiers 441 which are cascaded.

FIG. 6 illustrates a first embodiment of the post amplifier 44. Referring to FIG. 6, the post amplifier 44 includes cascaded sets, each of which includes a limiting amplifier 60 and an auto-offset cancellation portion (AOC) 61.

The limiting amplifiers 60 are basically differential amplifiers and operate in a linear region. Thus, when an input signal is greater than a specific value, the limiting amplifiers 60 generate limited output signals. If the limiting amplifiers 60 are cascaded, the amplitude of an output signal may be fixed.

Each of the AOCs 61 includes a peak value sensor (not shown) and an error amplifier (not shown). The peak value sensor senses the maximum and/or minimum levels from two outputs of the limiting amplifiers 60. The error amplifier amplifies a difference between the detected maximum and minimum levels and feeds the amplification result back to the limiting amplifiers 60 to compensate for the difference. Here, if the DC gain of the error amplifier is greater than the DC gain of the limiting amplifiers 60, the set including the limiting amplifiers 60 and the AOC 61 may cancel intrinsic offsets and offsets inherited from a signal output from the differential amplifier 432 of the single-to-differential converter 43 or from a signal input from an immediately preceding limiting amplifier 60. Here, an offset being amplified through a plurality of amplifier 441 makes the limiting amplifiers 60 to operate in a saturation region and affects the following discriminator 45. Thus, it is preferable to remove the offset.

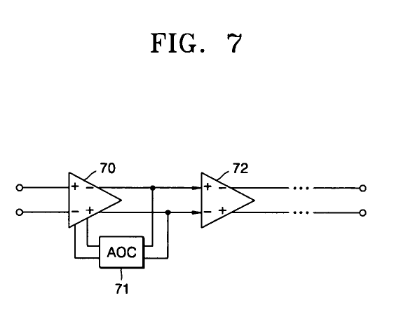

FIG. 7 illustrates a second embodiment of the post amplifier 44. Referring to FIG. 7, the post amplifier 44 includes a series of sets of a first limiting amplifier 70, an AOC 71, and a second limiting amplifier 72.

The post amplifier 44 having the above-described structure outputs a final signal with fixed amplitude in a predetermined range of an input optical signal power, i.e., in an operation range of the burst mode optical receiver. The discriminator 45 determines data of a logic “0” or “1” for differential signals output from the post amplifier 44, with reference to a threshold.

As described above, a burst mode optical receiver according to the present invention can output symmetrical differential signals that is robust to noise to a data recovery circuit connected thereto. Also, the use of the differential signals can contribute to a reduction in coupling outputs to inputs. As a result, the entire burst mode optical receiver can be easily integrated into a single chip and costs for the integration can be reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A burst mode optical receiver comprising:
a photodiode which converts an input optical signal into a current signal;
a pre-amplifier which converts the current signal into a voltage signal;
a single-to-differential converter which converts the single voltage signal output from the pre-amplifier into differential signals;
a post amplifier which amplifies the differential signals and cancels an offset occurring during the amplification or offsets inherited from the differential signals; and
a discriminator which discriminates data from the differential signals.

2. The burst mode optical receiver of claim 1, wherein the single-to-differential converter comprises a differential amplifier which receives a predetermined reference voltage as a first input and the single voltage signal as a second input to output symmetrical differential signals.

3. The burst mode optical receiver of claim 2, wherein the single-to-differential converter further comprises an auto threshold controller which detects maximum and minimum levels of the single voltage signal and provides a substantial middle value of the maximum and minimum levels as a first input to the differential amplifier.

4. The burst mode optical receiver of claim 3, wherein the auto threshold controller comprises:
a top holder which detects the maximum level of the single voltage signal and holds the maximum level for a predetermined period of time;
a bottom holder which detects the minimum level of the single voltage signal and holds the minimum level for a predetermined period of time; and
a voltage divider which detects the substantial middle value of the maximum and the minimum levels.

5. The burst mode optical receiver of claim 1, wherein the post amplifier comprises a series of sets, each of the sets comprising:
a limiting amplifier which amplifies the differential signals and cancels offsets inherited from the differential signals or an offset occurring during the amplification according to a predetermined control signal; and
a cascaded set of a plurality of auto-offset cancellation portions which calculates a difference between outputs of the limiting amplifier, amplifies the difference, and provides the amplification result as the predetermined control signal to the limiting amplifier.

6. The burst mode optical receiver of claim 5, wherein the limiting amplifier is a differrantial amplifier that operates in a linear region.

7. The burst mode optical receiver of claim 6, wherein the auto-offset cancellation portions comprises:
a peak value sensor which detects the maximum or minimum levels from the outputs of the limiting amplifier; and
an error amplifier which amplifies the difference between the maximum or minimum levels.

8. The burst mode optical receiver of claim 5, wherein the auto-offset cancellation portions comprises:
a peak value sensor which detects the maximum or minimum levels from the outputs of the limiting amplifier; and
an error amplifier which amplifies the difference between the maximum or minimum levels.

9. The burst mode optical receiver of claim 1, wherein the post amplifier comprises cascaded sets, each of the sets comprising:
a first limiting amplifier which amplifies the differential signals output from the single-to-differential converter and cancels the offsets inherited from the differential signals or the offset occurring during the amplification according to the predetermined control signal;
an auto offset cancellation portion which calculates a difference between the outputs of the first limiting amplifier, amplifies the difference, and provides the amplification result as the predetermined control signal to the first limiting amplifier; and
a second limiting amplifier which amplifies differential signals output from the first limiting amplifier.

10. The burst mode optical receiver of claim 9, wherein the first or second limiting amplifier is a differenctial amplifier that operates in a linear region.

11. The burst mode optical receiver of claim 10, wherein the auto-offset cancellation portion comprises:
a peak value sensor which detects the maximum and minimum levels from the outputs of the first limiting amplifier; and
an error amplifier which amplifies a difference between the maximum and minimum levels.

12. The burst mode optical receiver of claim 9, wherein the auto-offset cancellation portion comprises:
a peak value sensor which detects the maximum and minimum levels from the outputs of the first limiting amplifier; and
an error amplifier which amplifies a difference between the maximum and minimum levels.
